(19) United States
(12) Patent Application Publication
(10) Pub. No.: US 2006/0012931 A1
(43) Pub. Date: Jan. 19, 2006

(54) Three-pole circuit interrupter

(76) Inventors: Joseph C. Engel, Monroeville, PA (US); Charles J. Nochumson, Palatine, IL (US); Gary F. Saletta, Irwin, PA (US)

Correspondence Address: Martin J. Moran, Esquire;Eaton Electrical, Inc., Technology & Quality Center, 170 Industry Drive, RIDC Park West, Pittsburgh, PA, 15275-1032, US

(21) Appl. No.: 10/891,697

(22) Filed: Jul. 15, 2004

(51) Int. Cl. H02H 3/00

(52) U.S. Cl. 361/93.1

(57) ABSTRACT

A three-pole circuit breaker is for a three-phase load circuit including three phases and a line cycle. The three-pole circuit breaker includes three poles, each of which includes a set of separable contacts for a corresponding one of the phases of the three-phase load circuit, and a current sensor adapted to determine a plurality of current samples for the corresponding one of the phases during the line cycle. An operating mechanism is adapted to open and close the sets of separable contacts. A trip mechanism cooperates with the operating mechanism and is adapted to determine three current values from the current samples of the poles during at least about one half of the line cycle and to analyze differences among the current values, in order to detect a phase-to-phase arcing fault or a phase-to-ground arcing fault, and to responsively trip open the sets of separable contacts.

### BACKGROUND OF THE INVENTION

1. Field of the Invention

This invention pertains generally to electrical switching apparatus and, more particularly, to three-pole circuit interrupters responsive to arcing faults.

2. Background Information

Circuit interrupters, such as molded case circuit breakers, include at least one set of separable contacts per pole. For example, a first contact is fixed within the molded case housing and a second movable contact is coupled to an operating mechanism. These separable contacts are in electrical communication with either the line or the load coupled to the circuit breaker. The operating mechanism moves the movable contact between a first, open position wherein the movable contact is spaced from the fixed contact, and a second, closed position wherein the fixed and movable contacts are in contact and electrical communication. The operating mechanism may be operated manually or automatically by a trip mechanism.

Circuit breaker protective trip units may provide about four levels of protection: overload, short delay, instantaneous and ground protection. The most serious type of fault within a three-phase switchgear assembly is an arcing fault. The energy absorbed by the resulting gas plasma caused by the product of arc voltage times arc current over time can result in a rapid build up of internal pressure. This pressure can compromise the switchgear assembly's ability to contain the resulting gas without rupturing. The instantaneous protection, which has no deliberate delay, is intended to minimize equipment damage due to such an arcing fault. However, if the electrical system is such that during a phase-to-phase or phase-to-ground arcing fault the resulting current is below the instantaneous trip level, then a short delay trip will occur. In this instance, the corresponding non-instantaneous, short delay is very undesirable.

Accordingly, there is room for improvement in three-pole circuit interrupters.

### SUMMARY OF THE INVENTION

These needs and others are met by the present invention, which provides an additional protective function, namely, “intelligent” instantaneous protection, that responds to an arcing fault, such as a phase-to-phase or phase-to-ground arcing fault.

In accordance with one aspect of the invention, a three-pole circuit interrupter for a three-phase load circuit including three phases and a line cycle comprises: three poles, each of the poles comprising: a set of separable contacts for a corresponding one of the phases of the three-phase load circuit, and a current sensor adapted to determine a plurality of current samples for the corresponding one of the phases during the line cycle; an operating mechanism adapted to open and close the sets of separable contacts; and a trip mechanism cooperating with the operating mechanism, the trip mechanism adapted to determine three current values from the current samples of the three poles during at least about one half of the line cycle and to analyze differences among the current values of the poles, in order to detect a phase-to-phase arcing fault or a phase-to-ground arcing fault, and to responsively trip open the sets of separable contacts.

The trip mechanism may include a processor and a routine determining that at least one of the current values is above a first reference, and responsively analyzing the differences among the current values of the poles during the at least about one half of the line cycle. The routine may determine magnitudes of the current samples of the poles and sum the magnitudes to provide a sum as a corresponding one of the current values for each of the poles for the at least about one half of the line cycle.

The routine may be adapted to detect the phase-to-phase arcing fault between a pair of the phases of the three-phase load circuit associated with the two of the poles and to responsively trip open the sets of separable contacts due to the detected phase-to-phase arcing fault.

The trip mechanism may include a processor and a routine adapted to determine magnitudes of the current samples, to sum the magnitudes to provide a sum as a corresponding one of the current values for each of the poles for about one half of the line cycle, and to examine the sum for each of the poles after the about one half of the line cycle. The routine may be adapted to detect the phase-to-phase arcing fault between a pair of the phases of the three-phase load circuit and to responsively trip open the sets of separable contacts due to the detected phase-to-phase arcing fault.

The three-phase load circuit may further include a ground. The routine may be adapted to detect the phase-to-ground arcing fault between one of the phases of the three-phase load circuit and the ground and to responsively trip open the sets of separable contacts due to the detected phase-to-ground arcing fault.

The routine may integrate or sum absolute values of the current samples of the poles to provide the current values during the at least one half of the line cycle. The current values may be sums, and the routine may analyze differences among the sums during one half of the line cycle.

Each of the current values may be a sum of a plurality of absolute values of corresponding ones of the current samples during at least about one half of the line cycle, an average of a sum of a plurality of absolute values of corresponding ones of the current samples during at least about one half of the line cycle, a peak value of corresponding ones of the current samples during at least about one half of the line cycle, an RMS value of corresponding ones of the current samples during at least about one half of the line cycle, or a sum of the squares of corresponding ones of the current samples during at least about one half of the line cycle.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a three-pole circuit breaker in accordance with the present invention.

FIG. 2 is a block diagram of a three-phase power source connected to a three-phase load through the three-pole circuit breaker of FIG. 1.

FIG. 3A is a plot of a phase-to-phase arcing fault for the load circuit of FIG. 2.

FIG. 3B is a plot of a phase-to-ground arcing fault for the load circuit of FIG. 2.

FIGS. 4A-4B form a flow chart of a main loop routine for the processor of FIG. 1.

FIGS. 5A-5B form a flow chart of an interrupt routine for the processor of FIG. 1.

FIG. 6 is a flow chart of the arc flash routine of FIGS. 4A-4B.

FIG. 7 is a flow chart of a current sample summing routine of FIGS. 5A-5B.

FIG. 8 is a flowchart of another current sample summing routine in accordance with another embodiment of the invention.

FIGS. 9-12 are block diagrams of sub-routines to determine current values in accordance with other embodiments of the invention.

### DESCRIPTION OF THE PREFERRED EMBODIMENTS

The present invention is described in association with a three-pole circuit breaker, although the invention is applicable to a wide range of circuit interrupters having three or more poles. Examples of circuit breakers are disclosed in U.S. Pat. Nos. 4,752,853; 5,270,898; and 5,875,088, which are incorporated by reference herein.

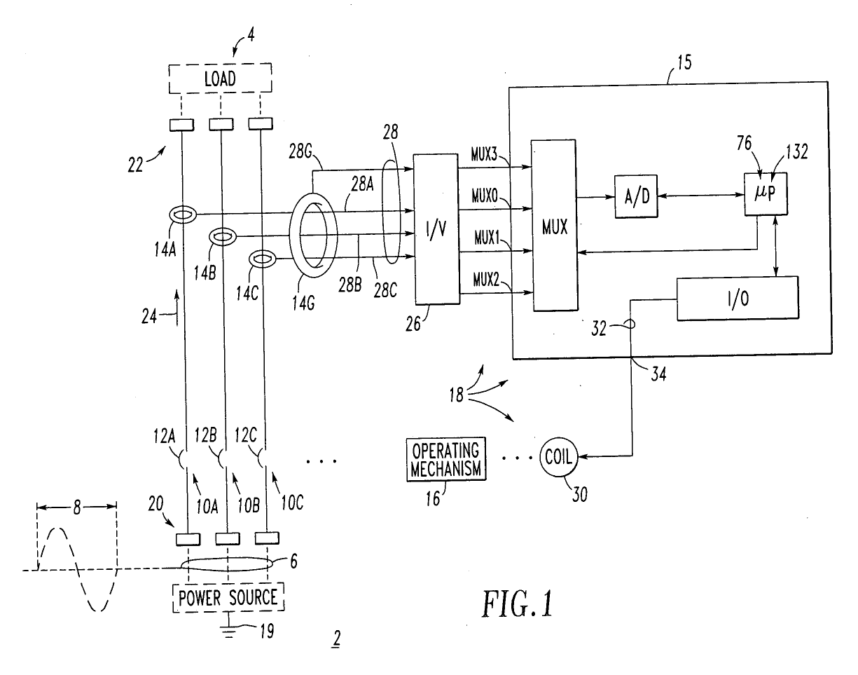

Referring to FIG. 1, a three-pole circuit interrupter, such as circuit breaker (CB) 2, is for a three-phase load circuit 4 including three phases 6 and a line cycle 8 for each of such phases. The CB 2 includes three poles 10A, 10B, 10C including sets of separable contacts 12A,12B,12C for a corresponding one of the three phases 6, and three current sensors, such as current transformers (CTs) 14A,14B,14C, respectively. The current sensors 14A,14B,14C and a processor 15 are adapted to determine a plurality of current values for the corresponding one of the three phases 6 during the line cycle 8.

### EXAMPLE 1

At least about six current samples may be determined per half-cycle of the line cycle 8 for each of the three phases 6. In this example, the current samples may be taken every about 30 degrees as referenced to one or more of the phases 6.

### EXAMPLE 2

As another example, if four current samples are taken per half-cycle of the line cycle 8, then the current samples may be taken every about 45 degrees as referenced to one of the phases 6. The current samples are taken about simultaneously with respect to one of the three phases 6. The current samples need not be synchronized to zero crossings of any of the three phases. They are, however, synchronized to the line frequency.

Continuing to refer to FIG. 1, an operating mechanism 16 is adapted to open and close the sets of separable contacts 12A,12B,12C. A trip mechanism, such as trip circuit 18, cooperates with the operating mechanism 16 and is adapted to determine three current values from the current samples of the three poles 10A,10B,10C during at least about one half of the line cycle and to analyze differences among the current values, in order to detect a phase-to-phase arcing fault between a pair of the phases 6 or a phase-to-ground arcing fault between one of the phases 6 and a ground, such as 19, and to responsively trip open the sets of separable contacts 12A,12B,12C.

The three sets of separable contacts 12A,12B,12C are electrically interconnected between three line terminals 20 and three load terminals 22 for movement between a closed position (not shown) and an open position (as shown in FIG. 1) in order to switch one or more electrical currents, such as current 24, flowing through the separable contacts 12A,12B,12C between the terminals 20,22.

The trip circuit 18 interfaces the CTs 14A, 14B, 14C for sensing the line electrical currents. Although not required, the trip circuit 18 may also interface a sensor, such as current transformer (CT) 14G, for sensing the ground electrical current. The trip circuit 18 includes a suitable current-to-voltage (I/V) interface 26 for receiving the sensed current signals 28 from the CTs 14A,14B,14C,14G, the processor 15 (e.g., including a microprocessor (μP)) and a trip coil 30 controlled by such processor. The sensed current signals 28 include a sensed ground current 28G and the sensed phase currents 28A,28B,28C, which may represent both normal and fault currents in the load circuit 4. In the event that the ground fault trip function is not employed, then the CT 14G for the signal 28G is removed and a jumper or switch (not shown) is employed to ground signal 28G.

The processor 15 employs a multiplexer (MUX) to select the sensed signals from the interface 26; an analog-to-digital (A/D) converter to convert the sensed signals to corresponding digital values; the microprocessor (μP) to receive the digital values from the A/D; and a digital input/output circuit (I/O) to input or output various signals, such as trip signal 32 at output port 34.

The operating mechanism 16 has a first state (e.g., closed) and a second state (e.g., open or tripped) which corresponds to the open position of the separable contacts 12A,12B,12C. The CTs 14A,14B,14C sense the electrical current, such as current 24, flowing through those separable contacts. The μP of the processor 15 employs the digital values of the sensed signals from the A/D to generate the trip signal 32 at output 34 for tripping the operating mechanism 16 through trip coil 30 to the tripped state to move the separable contacts 12A,12B,12C to the open position.

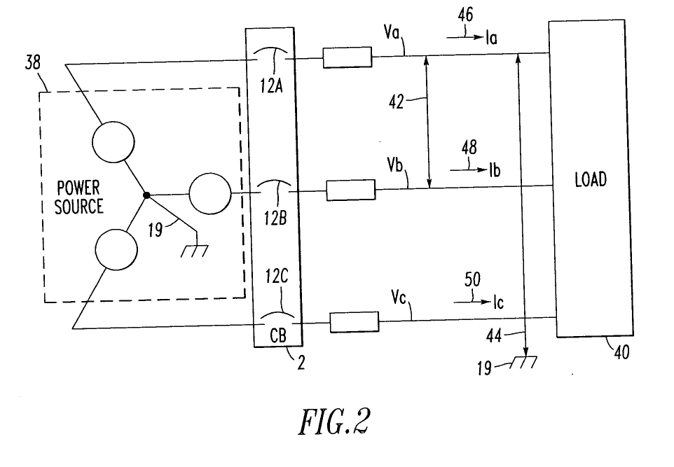

Referring to FIG. 2, a three-phase power source 38 is connected to a three-phase load 40 through the CB 2. Two arcing fault conditions are shown, a phase-to-phase arcing fault 42 (e.g., between the phase voltages Va and Vb) and a phase-to-ground arcing fault 44 (e.g., between the phase voltage Va and ground 19). A unique characteristic of a phase-to-phase arcing fault, such as 42, is the fact that two line currents, such as 46,48 (e.g., currents Ia and Ib), are relatively high, approximately equal and of opposite sign, while the third line current, such as 50 (e.g., current Ic), is normal (i.e., in the absence of the phase-to-ground arcing fault 44). This information may be employed to provide a relatively fast-acting intelligent instantaneous trip function as discussed, below, in connection with Example 3.

### EXAMPLE 3

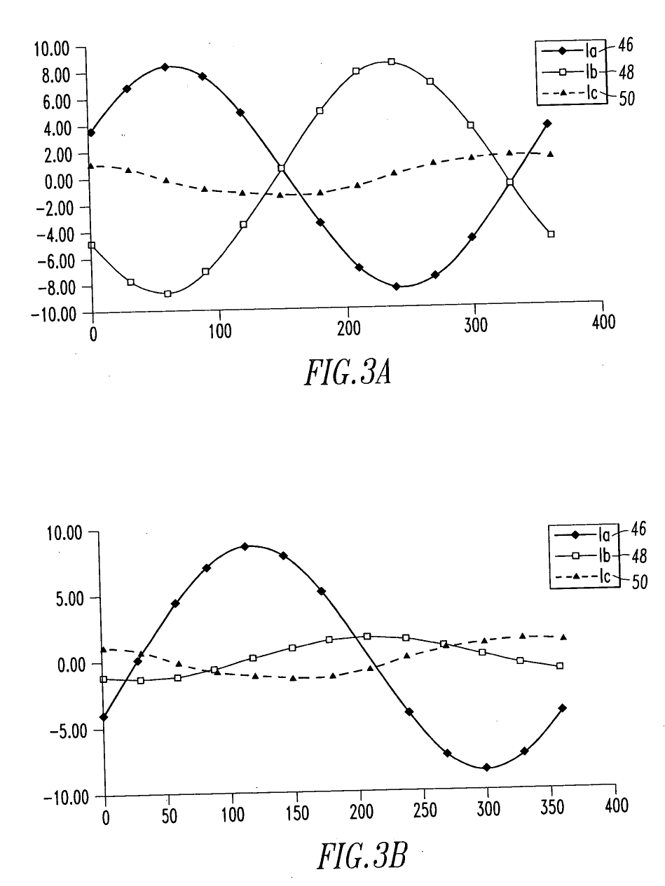

In this example, the normalized or per unit rated current (e.g., normally expressed as an RMS value) of the CB 2 is 1.000_{RMS} or 1.414_{PEAK}. The fast acting, intelligent, instantaneous trip function algorithm is as follows. If an instantaneous current sample of the three-phase currents Ia 46, Ib 48 or Ic 50 is greater than about 3 (which is greater than the peak value of a 2_{RMS} per unit sinusoidal wave), then the magnitudes of each of the three-phase currents Ia 46, Ib 48 and Ic 50 are summed for about one half-cycle (i.e., about one half the time of the line cycle 8 of FIG. 1). A plot of the three-phase currents Ia 46, Ib 48 and Ic 50 for this example is shown in FIG. 3A.

In this example, sampling is done about every 30 degrees of the line cycle 8 (e.g., about 12 times per line cycle or about 6 times per one half-cycle). Then, after one half-cycle, the three sums are examined. If two of the sums are about equal and above a first reference (e.g., about 14), and the other remaining sum is below a second reference (e.g., about 7), then the CB 2 is tripped due to a detected phase-to-phase arcing fault, such as 42 (FIG. 2).

Table 1, below, shows the three sums for six samples during a one half-cycle period. Here, after the sixth current sample, both of the |Ia| sum and the |Ib| sum are equal (e.g., 32.29) and are above the first reference (e.g., about 14), and the other remaining sum |Ic| (e.g., 5.28) is below a second reference (e.g., about 7). Hence, the CB 2 is tripped due to a detected phase-to-phase arcing fault, such as 42 of FIG. 2.

TABLE 1

| degrees | \|Ia\| sum | \|Ib\| sum | \|Ic\| sum |
|---|---|---|---|
| 0 | 3.59 | 4.87 | 1.22 |
| 30 | 10.54 | 12.56 | 1.93 |
| 60 | 18.99 | 21.01 | 1.93 |
| 90 | 26.68 | 27.96 | 2.64 |
| 120 | 31.55 | 31.55 | 3.86 |
| 150 | 32.29 | 32.29 | 5.28 |

### EXAMPLE 4

The detection of a phase-to-ground arcing fault, such as 44 (FIG. 2), can be triggered as before. If one of the one half-cycle sums is above a first reference (e.g., about 14), and the other two one half-cycle sums are less than a second reference (e.g., about 7), then the CB 2 is tripped due to a phase-to-ground arcing fault, such as 44. A plot of the three-phase currents Ia 46, Ib 48 and Ic 50 for this example is shown in FIG. 3B.

Table 2, below, shows the three sums for six samples during a one half-cycle period. Here, after the sixth current sample, both of the |Ib| sum and the |Ic| sum are equal (e.g., 5.28) and are below the second reference (e.g., about 7), and the other remaining sum |Ia| (e.g., 31.67) is above the first reference (e.g., about 14). Hence, the CB 2 is tripped due to the detected phase-to-ground arcing fault 44.

TABLE 2

| degrees | \|Ia\| sum | \|Ib\| sum | \|Ic\| sum |
|---|---|---|---|
| 0 | 4.24 | 1.22 | 1.22 |
| 30 | 4.24 | 2.64 | 1.93 |
| 60 | 8.49 | 3.86 | 1.93 |
| 90 | 15.83 | 4.57 | 2.64 |
| 120 | 24.32 | 4.57 | 3.86 |
| 150 | 31.67 | 5.28 | 5.28 |

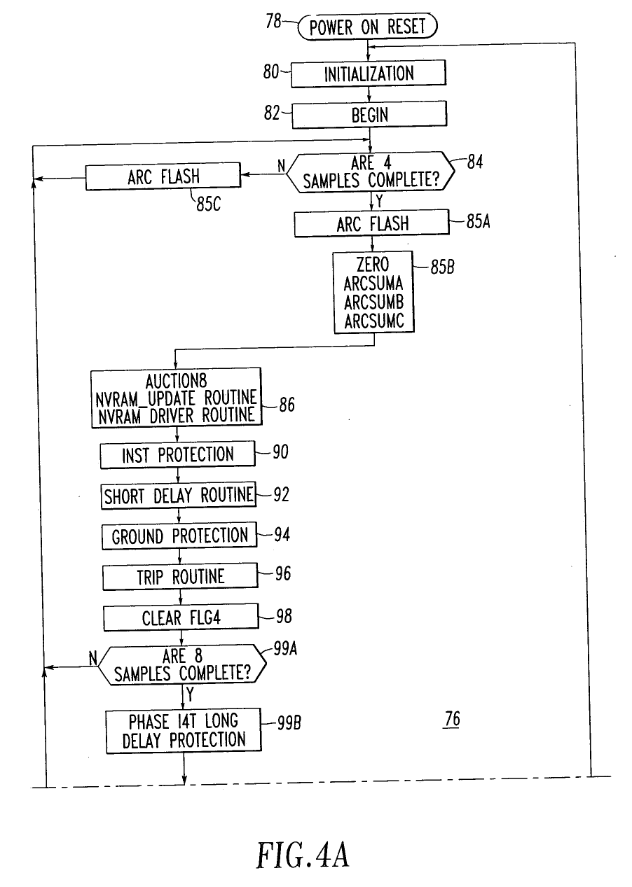

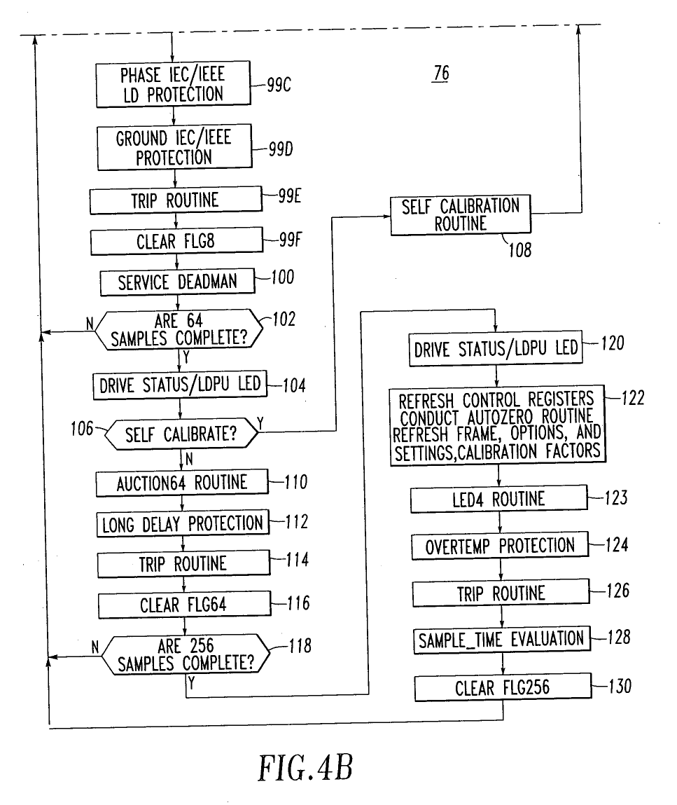

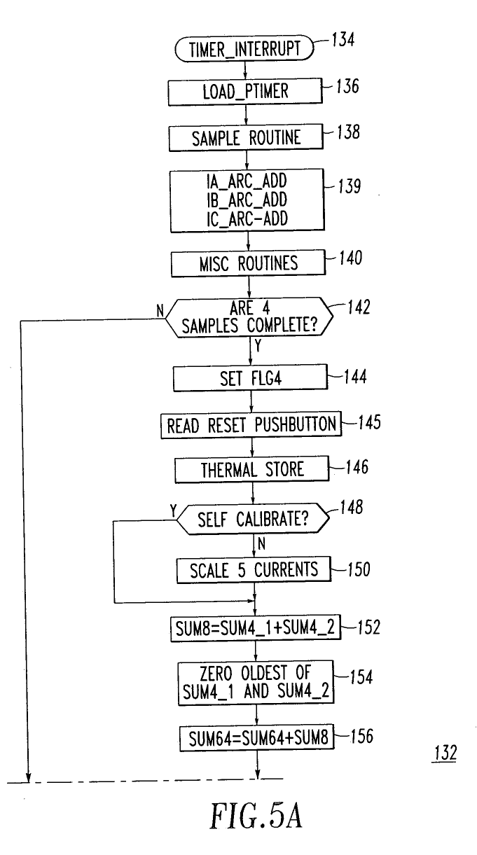

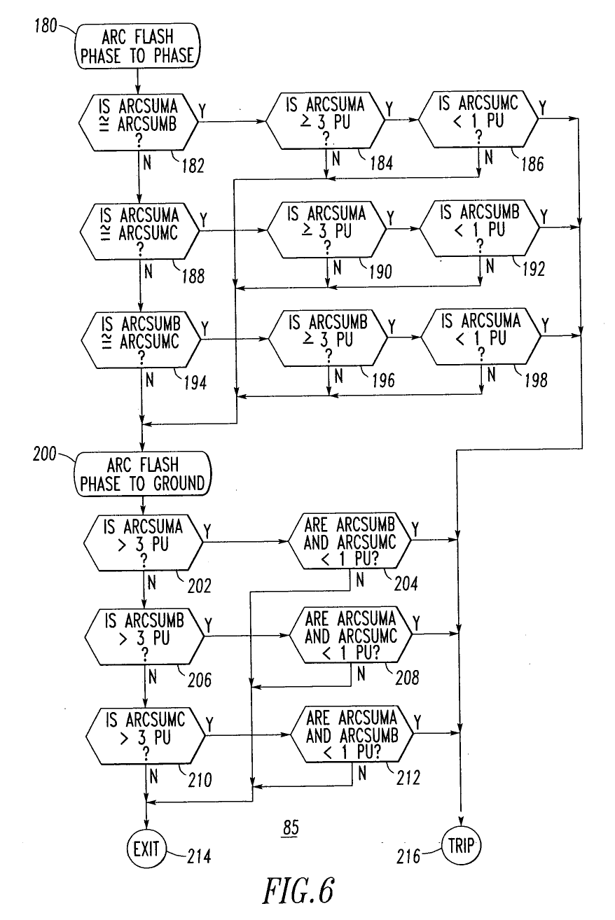

Referring to FIGS. 4A-4B, an exemplary main loop routine 76 is executed by the μP of processor 15 of FIG. 1. After a power on reset at 78, initialization is conducted at 80. Next, at 82, the principal portion of routine 76 begins. At 84, a flag (FLG4) is tested to determine if four current samples are completed. If so, then, at 85A, an Arc Flash routine 85 (FIG. 6) is executed. After 85A, values ARCSUMA (FIG. 7), ARCSUMB and ARCSUMC are zeroed at 85B. On the other hand, if four current samples are not completed at 84, then, at 85C, the Arc Flash routine 85 (FIG. 6) may also be executed, in order to speed up tripping in the presence of relatively very large currents. After 85C, step 84 is repeated.

After 85B, at 86, an auction8 routine finds the largest sum of eight squared current values for the three phases 6, and any data that needs written to non-volatile random access memory (NVRAM) (not shown) is written at this time. Next, at 90, an instantaneous protection routine is executed. This routine compares the highest sum of squared current values for the phases 6 with a corresponding instantaneous setpoint value. Then, at 92 and 94, a short delay interlock and protection routine and a ground protection routine, respectively, are executed. The short delay routine 92 compares the highest sum of squared current values for the phases 6 with the short delay setpoint and, if exceeded, a pickup occurs and a tally value is added to a short time tally (STALLY) value which is, in turn, compared with the short time setting and, if greater, a short flag is set for eventual tripping. A similar set of sequences occurs for the ground fault routine 94. At 96, a trip routine is executed which generates the trip signal 32 at output 34 of FIG. 1 in the event any trip conditions were detected at steps 90,92,94. Then, at 98, the flag (FLG4), which was tested at 84, is cleared.

At 99A, a flag (FLG8) is tested to determine if eight current samples are completed. If not, then step 84 is repeated. Otherwise, at 99B, a phase 14T long delay protection routine is executed. This is followed by a phase IEC/IEEE long delay protection routine, at 99C of FIG. 4B, and a ground IEC/IEEE protection routine, at 99D. At 99E, a trip routine is executed which generates the trip signal 32 at output 34 of FIG. 1 in the event any trip conditions were detected at steps 99B,99C,99D. Then, at 99F, the flag (FLG8), which was tested at 99A, is cleared before a deadman timer (not shown) for processor 15 is updated at 100.

Next, at 102, a flag (FLG64) is tested to determine if 64 current samples are completed. If not, then step 84 is repeated. Otherwise, at 104, the STATUS/LDPU or long delay pickup LED (not shown) is serviced by driving a latch (not shown) external to the μP of processor 15. Next, at 106, if self calibration is selected by a jumper (not shown) at the factory, then a self calibration routine, at 108, calculates calibration values for the phase and ground sensed current signals 28 and stores these in NVRAM (not shown). The calibration procedure employs precision current sources (three phases and ground) (not shown) and is automatically performed by the trip circuit 18. After the self calibration routine is executed at 108, the initialization is repeated at 80. Otherwise, if there is no self calibration, then at 110 and 112, auction64 and long delay protection routines, respectively, are executed. These routines find the highest sum of 64 squared current values for the phases 6 and use this value for long delay pickup and long time tally developed values. At 114, a trip routine is executed which generates the trip signal 32 at output 34 of FIG. 1 in the event any trip flag conditions were detected at step 112. Then, at 116, the flag (FLG64), which was tested at 102, is cleared.

Next, at 118, a flag (FLG256) is tested to determine if 256 current samples are completed. If not, then step 84 is repeated. Otherwise, at 120, the STATUS/LDPU LED is again updated as at 104. Then, at 122, 123 and 124, refresh routines, a LED4 routine and over-temperature protection routines, respectively, are executed. The refresh routines refresh key protection parameters such as switch settings. At 126, a trip routine is executed which generates the trip signal 32 at output 34 of FIG. 1 in the event any trip conditions were detected at step 124. At 128, a sample_time evaluation routine is executed. This routine automatically selects the sampling interval for either a 50 Hz or 60 Hz sampling schedule. Then, at 130, the flag (FLG256), which was tested at 118, is cleared, after which step 84 is repeated.

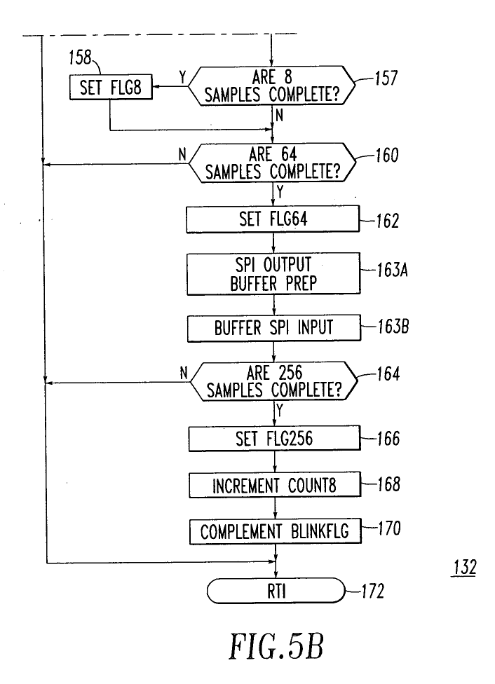

Referring to FIGS. 5A-5B, an exemplary interrupt routine 132 is executed by the μP of processor 15 of FIG. 1. In response to a periodic timer interrupt of the processor 15, at 134, a load_ptimer routine is executed at 136. This routine loads an internal timer of processor 15 with a value per a predefined schedule that will provide the next time interrupt. Next, at 138, the sensed signals from the interface 26 at MUX0-MUX3 of FIG. 1 are sampled. Then, at 139, routines IA_ARC_ADD 220 (FIG. 7), IB_ARC_ADD and IC_ARC_ADD are executed. These routines determine the magnitudes of the current values of the poles 10A,10B,10C and sum the magnitudes to provide sums for each of such poles for one half of the line cycle 8 in this example.

In this example, the routine 132 executes about every 45 degrees of the line cycle 8 of FIG. 1. This permits the Arc Flash routine 85 of FIG. 6 to analyze differences among the three sums of step 139 of the poles 10A,10B,10C (FIG. 1) during about one half of that line cycle 8.

At 140, miscellaneous routines (e.g., an accessory bus INCOM routine, SPI_Master communications, read jumper routine, read interlock-in and increment COUNT256) are executed which read an interlock input signal (not shown) at an input port (not shown) of FIG. 1, and increment a counter (COUNT256) which has the count for the sample routine 138.

Next, at 142, if a multiple of four current samples has not been obtained, as determined from the value of the counter (COUNT256) of step 140, then a return from interrupt (RTI) is executed at 172 (FIG. 5B). Otherwise, at 144 (FIG. 5A), the flag FLG4 is set. Then, at 145, a reset pushbutton (not shown) is read. At 146, a thermal store routine is executed which reads a thermal memory capacitor voltage (not shown) and digitally adjusts its value. At 148, if self calibration (as discussed above in connection with steps 106,108 of FIG. 4B) is not selected, then five (i.e., three phase currents and one ground current, as shown in FIG. 1, plus one neutral current (not shown)) current samples are scaled at 150 before step 152 is executed. Otherwise, if self calibration is selected at 148, then execution resumes with 152 which, for each of the five currents, a sum (SUM8) of the last eight current samples is determined from the sum (SUM4_1) of the latest four current samples plus the sum (SUM4_2) of the previous four current samples. Then, at 154, the oldest sum of the two sums (SUM4_1 and SUM4_2) of step 154 is zeroed.

Next, at 156, a sum, Sum64, is set equal to the previous value of that sum plus the sum, Sum8, of step 152. Then, at 157 (FIG. 5B), if a multiple of eight current samples has not been obtained, as determined from the value of the counter (COUNT256) of step 140 (FIG. 5A), then execution resumes at 160. Otherwise, at 158 (FIG. 5B), the flag FLG8 is set.

Next, at 160, if a multiple of 64 current samples have not been obtained, as determined from the value of the counter (COUNT256) of step 140, then a return from interrupt (RTI) is executed at 172. Otherwise, at 162, the flag FLG64 is set. Then, at 163A, the SPI output buffer of a serial port (not shown) is prepared and, at 163B, the SPI input of that serial port is buffered. At 164, if a multiple of 256 current samples have not been obtained, as determined from the value of the counter (COUNT256) of step 140, then a return from interrupt (RTI) is executed at 172. Otherwise, at 166, the flag FLG256 is set. At 168, a counter COUNT8 is incremented (for use by units with a multiplexed display (not shown)) after which, at 170, a flag (BLINKFLG), which is used to control a status LED (not shown), is complemented. Finally, at 172, the return from interrupt (RTI) is executed.

FIG. 6 shows the Arc Flash routine 85, which includes an arc flash phase-to-phase portion 180 and an arc flash phase-to-ground portion 200. After 180, at 182, the value ARCSUMA is compared to the value ARCSUMB. If these values are about equal (e.g., without limitation, within about 20%; within about 5%; within a suitable percentage; within a suitable deadband), then, at 184, it is determined if the value ARCSUMA is greater than or equal to a reference (e.g., about three times rated current in this example). If so, then, at 186, it is determined if the value ARCSUMC is less than another reference (e.g., about one times rated current in this example). If so, then a trip is generated at 216 by setting the trip signal 32 at output 34 of FIG. 1.

If either of the tests at 184 or 186 failed, then execution resumes at 200. If the test at 182 failed, then, at 188, the value ARCSUMA is compared to the value ARCSUMC. If these values are about equal (e.g., as discussed above in connection with step 182), then, at 190, it is determined if the value ARCSUMA is greater than or equal to a reference (e.g., as discussed above in connection with step 184). If so, then, at 192, it is determined if the value ARCSUMB is less than a reference (e.g., as discussed above in connection with step 186). If so, then a trip is generated at 216 by setting the trip signal 32 at output 34 of FIG. 1.

If either of the tests at 190 or 192 failed, then execution resumes at 200. If the test at 188 failed, then, at 194, the value ARCSUMB is compared to the value ARCSUMC. If these values are about equal (e.g., as discussed above in connection with step 182), then, at 196, it is determined if the value ARCSUMB is greater than or equal to a reference (e.g., as discussed above in connection with step 184). If so, then, at 198, it is determined if the value ARCSUMA is less than a reference (e.g., as discussed above in connection with step 186). If so, then a trip is generated at 216 by setting the trip signal 32 at output 34 of FIG. 1.

If any of the tests at 194, 196 or 198 failed, then execution resumes at 200 for the arc flash phase-to-ground portion 200 of the Arc Flash routine 85. At 202, it is determined if the value ARCSUMA is greater than a suitable first reference (e.g., about three times rated current in this example). If so, then, at 204, it is determined if the values ARCSUMB and ARCSUMC are both less than a second reference (e.g., about one times rated current in this example). If so, then a trip is generated at 216 by setting the trip signal 32 at output 34 of FIG. 1. On the other hand, if the test at 204 fails, then the routine exits at 214.

If the test at 202 failed, then execution resumes at 206, which determines if the value ARCSUMB is greater than the first reference (e.g., as discussed above in connection with step 202). If so, then, at 208, it is determined if the values ARCSUMA and ARCSUMC are both less than a second reference (e.g., as discussed above in connection with step 204). If so, then a trip is generated at 216 by setting the trip signal 32 at output 34 of FIG. 1. On the other hand, if the test at 208 fails, then the routine exits at 214.

If the test at 206 failed, then execution resumes at 210, which determines if the value ARCSUMC is greater than the first reference (e.g., as discussed above in connection with step 202). If so, then, at 212, it is determined if the values ARCSUMA and ARCSUMB are both less than the second reference (e.g., as discussed above in connection with step 204). If so, then a trip is generated at 216 by setting the trip signal 32 at output 34 of FIG. 1. On the other hand, if the test at 210 or 212 fails, then the routine exits at 214.

FIG. 7 shows the IA_ARC_ADD routine 220 of step 139 of FIG. 5A for pole 10A (FIG. 1), it being understood that the IB_ARC_ADD routine and the IC_ARC_ADD routine function in a like manner for the other two poles 10B and 10C, respectively. In this example, the current samples are taken by the routine 132 of FIGS. 5A-5B every 45 degrees of the line cycle 8 of FIG. 1, such that four current samples for each of those poles are taken in about 180 degrees of that line cycle.

The routine 220 begins at 222 after which it is determined, at 224, if four current samples for pole 10A (FIG. 1) have been summed. This is determined if FLG4 (FIG. 5A) is set. If so, then the routine 220 exists at 226. On the other hand, if four current samples have not been summed, then, at 228, it is determined if the magnitude of the current sample (i.e., |Ia|) is greater than the peak value of a 7 per unit sine wave (e.g., the peak value of a sine wave corresponding to seven times rated current of the CB 2 of FIG. 1). If so, then, at 230, the value ARCSUMA is incremented by the 7 per unit peak value. This limits each current sample to a maximum value corresponding to the peak of the 7 per unit sine wave, which limits the effect of noise should noise affect a current sample. Next, the routine 220 exits at 232. Otherwise, if the test at 228 fails, then, at 234, the value ARCSUMA is incremented by the magnitude of the current sample (i.e., |Ia|). Finally, the routine 220 exits at 236.

FIG. 8 shows another IA_ARC_ADD routine 220′ suitable for step 139 of FIG. 5A for pole 10A (FIG. 1). In this example, the current samples are taken by the routine 132 of FIGS. 5A-5B every 45 degrees of the line cycle 8 of FIG. 1, such that sixteen current samples are taken in about two of those line cycles. Hence, the routine 220′ integrates or sums absolute values of the current samples of the pole 10A during four half-cycles of the line cycle 8. The routine 220′ begins at 222′ after which it is determined, at 224′, if sixteen current samples for pole 10A (FIG. 1) have been summed. This is determined if a flag (FLG 16) (not shown) is set. Otherwise, the routine 220′ is the same as the routine 220 of FIG. 7.

### EXAMPLE 5

Although a three-pole circuit breaker 2 (FIG. 1) is disclosed, the invention is applicable to greater counts of poles. For example, the invention is applicable to a four-pole circuit breaker (not shown) that switches a neutral conductor (not shown).

### EXAMPLE 6

Although a phase-to-ground fault 44 (FIG. 2) is disclosed in which the ground is an earth ground 19, the invention is applicable to other types of phase-to-ground faults in which the ground is a neutral conductor (not shown).

### EXAMPLE 7

Although a grounded power source 38 (FIG. 2) including the earth ground 19 is disclosed, the invention is applicable to a wide range of power sources (not shown), which are not grounded. In this example, the Arc Flash routine 85 of FIG. 6 will detect both phase-to-phase arcing faults and two or more concurrent phase-to-ground arcing faults.

### EXAMPLE 8

Although a grounded WYE power source 38 (FIG. 2) is disclosed, the invention is applicable to ungrounded or corner-grounded DELTA power sources (not shown).

### EXAMPLE 9

As a refinement of step 139 of the interrupt routine 132 of FIG. 5A and the routine 220 of FIG. 7, the three summing routines, such as 220′ (FIG. 8) or 220 (FIG. 7), may be executed only if at least one of the three samples from step 138 is greater than a suitable reference (e.g., without limitation, a suitable non-zero value).

### EXAMPLE 10

As shown in FIG. 7, for the pole 10A, the current value for that pole is a sum of a plurality of absolute values of the corresponding current samples during at least about one half of the line cycle 8 of FIG. 1. The current values for the other poles 10B, 10C are determined in a similar manner.

### EXAMPLE 11

Referring to FIG. 9, as a refinement of Example 10, each of the three current values, such as the current value for the pole 10A of FIG. 1, is an average 238 of the sum of a plurality (e.g., without limitation, N=4, 6, 8 or more) of absolute values (e.g., |Ia|) of corresponding ones of the current samples (e.g., Ia) during at least about one half of the line cycle 8 of FIG. 1.

### EXAMPLE 12

As shown in FIG. 10, each of the three current values, such as the current value for the pole 10A of FIG. 1, is a peak value 240 of corresponding ones of the current samples (e.g., 1a) during at least about one half of the line cycle 8 of FIG. 1.

### EXAMPLE 13

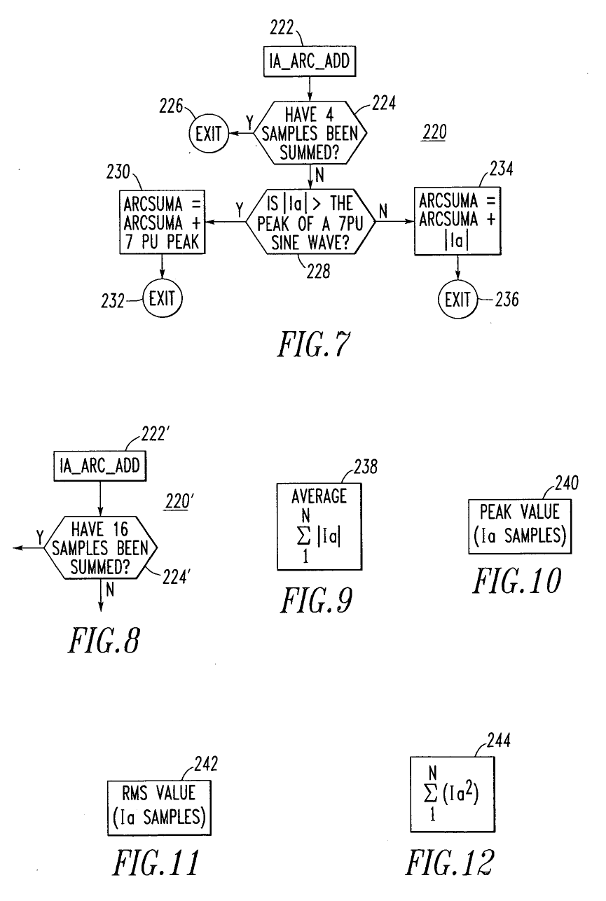

As shown in FIG. 11, each of the three current values, such as the current value for the pole 10A of FIG. 1, is an RMS value 242 of corresponding ones of the current samples (e.g., Ia) during at least about one half of the line cycle 8 of FIG. 1.

### EXAMPLE 14

As shown in FIG. 12, each of the three current values, such as the current value for the pole 10A of FIG. 1, is a sum of the squares value 244 (i.e., a squared RMS value) of a plurality (e.g., without limitation, N=4, 6, 8 or more) of corresponding ones of the current samples (e.g., Ia) during at least about one half of the line cycle 8 of FIG. 1.

### EXAMPLE 15

As an alternative to Examples 3 and 4, in which a first reference (e.g., about 7) and a second reference (e.g., about 14) are employed with six samples per half cycle, if, for example, eight samples per half cycle were employed, then the first and second references would be adjusted by a factor of 8/6 to provide the first reference (e.g., about 9.33) and the second reference (e.g., about 18.67) for this example.

### EXAMPLE 16

As an alternative to Examples 3, 4 and 15, if the average value of the sum was employed, then the first and second references would be adjusted by the count of the samples (i.e., 6 for Examples 3 and 4; 8 for Example 15). In this example, the first and second references are independent of the count of samples, such that the first reference is about 1.167 (e.g., about 7/6 or about 9.33/8) and the second reference is about 2.33 (e.g., about 14/6 or about 18.67/8).

### EXAMPLE 17

As an alternative to Examples 3, 4, 15 and 16, any suitable values of the first and second references and/or counts of the samples and/or period of the sampling may be employed.

Although the trip circuit 18 includes a processor 15, it will be appreciated that a combination of one or more of analog, digital and/or processor-based circuits may be employed.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A three-pole circuit interrupter for a three-phase load circuit including three phases and a line cycle, said three-pole circuit interrupter comprising:
three poles, each of said poles comprising:
a set of separable contacts for a corresponding one of the phases of said three-phase load circuit, and
a current sensor adapted to determine a plurality of current samples for the corresponding one of said phases during said line cycle;
an operating mechanism adapted to open and close said sets of separable contacts; and
a trip mechanism cooperating with said operating mechanism, said trip mechanism adapted to determine three current values from the currents samples of said three poles during at least about one half of said line cycle and to analyze differences among the current values of said poles, in order to detect a phase-to-phase arcing fault or a phase-to-ground arcing fault, and to responsively trip open said sets of separable contacts.

2. The three-pole circuit interrupter of claim 1 wherein said trip mechanism comprises a processor and a routine determining that at least one of said current values is above a first reference, and responsively analyzing said differences among the current values of said poles during said at least about one half of said line cycle.

3. The three-pole circuit interrupter of claim 2 wherein said three-pole circuit interrupter has a rated current; and wherein said first reference is about three times said rated current.

4. The three-pole circuit interrupter of claim 2 wherein said routine further determines magnitudes of said current samples of said poles and sums said magnitudes to provide a sum as a corresponding one of said current values for each of said poles for said at least about one half of said line cycle.

5. The three-pole circuit interrupter of claim 4 wherein said routine further analyzes said sum for each of said poles to identify a first current sum and a second current sum associated with two of said poles, said first and second current sums being above a second reference, and to identify a third current sum associated with the other of said poles, said third current sum being below a third reference, said third reference being less than said second reference.

6. The three-pole circuit interrupter of claim 5 wherein said routine is adapted to detect said phase-to-phase arcing fault between a pair of the phases of said three-phase load circuit associated with said two of said poles and to responsively trip open said sets of separable contacts due to said detected phase-to-phase arcing fault.

7. The three-pole circuit interrupter of claim 5 wherein said routine is adapted to sample said current samples every about 30 degrees to about 45 degrees of said line cycle.

8. The three-pole circuit interrupter of claim 1 wherein said trip mechanism comprises a processor and a routine adapted to determine magnitudes of said current samples, to sum said magnitudes to provide a sum as a corresponding one of said current values for each of said poles for about one half of said line cycle, and to examine said sum for each of said poles after said about one half of said line cycle.

9. The three-pole circuit interrupter of claim 8 wherein said routine is further adapted to detect said phase-to-phase arcing fault between a pair of the phases of said three-phase load circuit and to responsively trip open said sets of separable contacts due to said detected phase-to-phase arcing fault.

10. The three-pole circuit interrupter of claim 4 wherein said routine further analyzes said sum for each of said poles to identify a first current sum associated with one of said poles, said first current sum being above a second reference, and to identify a second current sum and a third current sum associated with the other two of said poles, said second and third current sums being below a third reference, said third reference being less than said second reference.

11. The three-pole circuit interrupter of claim 10 wherein said three-phase load circuit further includes a ground; and wherein said routine is adapted to detect said phase-to-ground arcing fault between one of the phases of said three-phase load circuit and said ground and to responsively trip open said sets of separable contacts due to said detected phase-to-ground arcing fault.

12. The three-pole circuit interrupter of claim 10 wherein said routine is adapted to sample said current samples every about 30 degrees to about 45 degrees of said line cycle.

13. The three-pole circuit interrupter of claim 1 wherein said trip mechanism comprises a processor and a routine which integrates or sums absolute values of said current samples of said poles to provide said current values during said at least one half of said line cycle.

14. The three-pole circuit interrupter of claim 13 wherein said current values are sums; and wherein said routine analyzes differences among said sums during one half of said line cycle.

15. The three-pole circuit interrupter of claim 1 wherein said trip mechanism comprises a processor and a routine which integrates or sums absolute values of said current samples of said poles to provide said current values during a plurality of half-cycles of said line cycle.

16. The three-pole circuit interrupter of claim 1 wherein each of said current values is a sum of a plurality of absolute values of corresponding ones of said current samples during at least about one half of said line cycle.

17. The three-pole circuit interrupter of claim 1 wherein each of said current values is an average of a sum of a plurality of absolute values of corresponding ones of said current samples during at least about one half of said line cycle.

18. The three-pole circuit interrupter of claim 1 wherein each of said current values is a peak value of corresponding ones of said current samples during at least about one half of said line cycle.

19. The three-pole circuit interrupter of claim 1 wherein each of said current values is an RMS value of corresponding ones of said current samples during at least about one half of said line cycle.

20. The three-pole circuit interrupter of claim 1 wherein each of said current values is a sum of the squares of corresponding ones of said current samples during at least about one half of said line cycle.
